(19) United States
(12) Patent Application Publication
(10) Pub. No.: US 2012/0006745 A1
(43) Pub. Date: Jan. 12, 2012

(54) Methods and Systems for Producing Granules of Biomass in the Treatment of Wastewater

(75) Inventors: Scott Kaley, Naperville, IL (US); Carolyn Schmit, Naperville, IL (US); Meltem Urgun-Demirtas, Naperville, IL (US)

(73) Assignee: BP Corporation North America Inc., Warrenville, IL (US)

(21) Appl. No.: 12/982,244

(22) Filed: Dec. 30, 2010

Related U.S. Application Data
(60) Provisional application No. 61/291,147, filed on Dec. 30, 2009.

(51) Int. Cl. C02F 3/30; C02F 3/12

(52) U.S. Cl. 210/605; 210/195.3

(57) ABSTRACT

Methods and systems for the production of granules of biomass in the treatment of wastewater. Organic matter is removed from wastewater in an anaerobic zone and then in an aerobic zone. Waste activated sludge is transferred from the aerobic zone to the anaerobic zone and is used in the formation of granulated biomass in the anaerobic zone. Excess granulated biomass may be removed from the anaerobic zone.

### RELATED APPLICATIONS

This application claims priority to U.S. Ser No. 61/291,147, filed Dec. 30, 2009, which is incorporated herein by reference in its entirety.

### FIELD OF THE INVENTION

The present invention relates to the methods and systems for treating wastewater. In particular, the invention relates to methods and systems producing granules of biomass in the treatment of wastewater.

### BACKGROUND OF THE INVENTION

Wastewaters from industrial processes or from municipal sewage contain significant amounts of organic matter that must be removed. Conventional systems for treating wastewaters have used microorganisms aggregated into a biomass, sometimes known as activated sludge, to digest the organic matter. Such systems typically include two stages—a primary, anaerobic zone containing a granular biomass, and a secondary, aerobic zone containing an activated sludge. The anaerobic zone is generally more cost effective for removing the bulk of organic matter, but often is unable to lower the concentration of organic matter beyond a certain level, for example, about 800 ppm chemical oxygen demand (COD). Aerobic reactors are used to bring the concentration of organic matter down to lower levels, for example, about 100 ppm COD.

The activated sludge is useful in removing the organic matter, but over time the growth of bio-organisms in the activated sludge requires that a portion be purged from the system. One of the liabilities of aerobic wastewater treatment is the need to dispose of excess activated sludge, sometimes known as waste activated sludge, formed in the aerobic zone. Typically, the waste activated sludge must be treated by one or more chemical, thermal, or mechanical methods before disposal. The removed waste activated sludge typically consists of about 85% to 99% water, which must be separated from the sludge, with a filtering process such as a belt press. The resulting cake may be incinerated or landfilled, or treated by other processes. All of these methods add cost to the process and have environmental consequences.

Some prior systems have attempted to dispose of the waste activated sludge by transferring it to the anaerobic zone. However, such prior systems have found it necessary to treat the waste activated sludge before feeding to the anaerobic zone. For example, some prior art systems have used mechanical destruction of the aerobic cells. These types of treatment processes add to the cost of the process.

A liability of the anaerobic process in previous systems has been in loss of biomass in the anaerobic reactors, particularly those that are structured to use granulated biomass. A particularly well suited anaerobic reactor is known as an upflow anaerobic sludge blanket reactor (UASB), which utilizes fluidized biomass granules in an upflowing configuration. Prior USAB reactors have shown a tendency to lose granule inventory over time, as the effluent from the anaerobic reactor flows into the aerobic reactor. The lost granules must be replaced with an outside source of granules which adds cost to the process and risks upset to the system. Furthermore, another problem in the existing anaerobic reactors is that they tend to have a significant build-up of heavy metals over time.

Accordingly, there remains a need for improvements in the processing of wastewater, particularly in the supply and disposal of biomass in both anaerobic and aerobic reactors.

### SUMMARY OF THE INVENTION

The present invention addresses a number of the problems in prior wastewater treatment systems. The invention reduces or eliminates the need for costly downstream handling, treating, and disposal of waste activated sludge from the aerobic zone. The invention also reduces or eliminates the need to purchase costly biomass granules for the anaerobic zone.

According to one aspect of the invention, a method for treating wastewater includes first removing organic matter from the wastewater in an anaerobic zone and forming granules of a biomass. The wastewater effluent from the anaerobic zone is transferred to an aeration zone, where the effluent is treated with a source of oxygen and an activated sludge to further remove organic matter from the wastewater effluent and to form additional activated sludge. A portion of the activated sludge from the aeration zone is transferred to the anaerobic zone. The growth yield of the granules of biomass in the anaerobic zone greater than about 6.0%.

According to another aspect of the invention, excess granules of biomass are removed from the anaerobic zone.

According the further aspect of the invention, a system for the treatment of wastewater includes an anaerobic zone, an aerobic zone, a sludge transfer line fluidly connecting the anaerobic zone and the aerobic zone, and an outlet in the anaerobic zone for removing granules of biomass. The anaerobic zone has a wastewater inlet and contains granules of a biomass adapted to remove organic matter in the wastewater and form additional granules of the biomass. The sludge transfer line transfers activated sludge from the aerobic zone to the anaerobic zone.

The foregoing aspects of the invention are illustrative of those that can be achieved by the present invention and are not intended to be exhaustive or limiting of the possible advantages which can be realized. Thus, these and other aspects of the invention will be apparent from the description herein or can be learned from practicing the invention, both as embodied herein or as modified in view of any variation which may be apparent to those skilled in the art.

### BRIEF DESCRIPTION OF THE DRAWINGS

FIG. 1 is a schematic representing one embodiment of the system of the present invention.

### DETAILED DESCRIPTION OF THE PREFERRED EMBODIMENTS

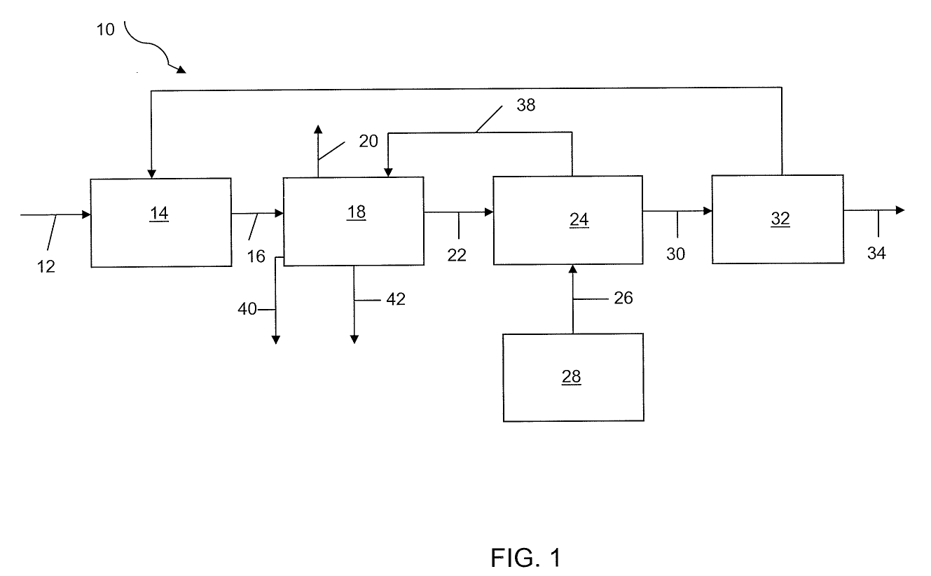

Referring now to FIG. 1, a system according to one embodiment of the present invention is shown generally at 10. Wastewater enters the system 10 through inlet line 12. The wastewater may be from any source, such as from an industrial process, or from municipal sewage. Examples of industrial processes include oil and gas refineries, chemical plants, fermenters, and the like. According to one embodiment of the invention, the source of industrial wastewater is from the manufacture and separation of chemicals and refinery products, and in one particular embodiment, from the manufacture and separation of aromatic chemicals, such as benzene, toulene, xylenes, and aromatic acids such as terephthalic acid and purified terephthalic acid. According to another particular embodiment, the source of industrial wastewater is from the manufacture, separation or purification of biofuels, including biogasolines such as ethanol and butanol; biodiesels; and biodistillates.

The wastewater inlet line 12 feeds into a surge or equalization tank 14. After equalization, the wastewater is fed through line 16 into an anaerobic zone 18. In FIG. 1, the anaerobic zone is shown schematically as a single reactor, however, the skilled artisan will recognize that the anaerobic zone could be configured in a number of reactors in a series or parallel configuration. The skilled artisan will also recognize that a number of control devices, such as a valves, gauges, and pumps are well-known in the art and have been left out of FIG. 1 and this description.

The anaerobic zone 18 contains a biomass suitable for removing organic matter from the wastewater. The biomass contains micro-organisms capable of digesting the organic matter in an anaerobic environment, and thus producing additional biomass. The biomass may be in the form of a slurry or sludge, but preferably is predominately in the form of solid granules. In the latter case, according to one particular embodiment of the invention, the anaerobic may be configured as an upflow anaerobic sludge blanket reactor (UASB).

Typically, the reactor(s) of the anaerobic zone 18 is operated at about 100° F. The reactor(s) of the anaerobic zone 18 may carry any suitable granular sludge inventory, for example, about 7% by weight total suspended solids (TSS), of which about 70% is volatile suspended solids (VSS). Suitable granules will have an average settling velocity of at least 20 m/hr and preferably about 75 m/hr to about 125 m/hr. Suitable granular biomass is known in art and commercially available.

The anaerobic zone 18 is operated such that enough organic matter in the effluent from the anaerobic zone 18 will have an organic content on the order of 500 to 800 ppm COD. A typical organic removal rate is about 1 unit of COD removed per day per 2 units of volatile suspended solids.

The digestion of the organic material in the anaerobic zone 18 results in the production of a biogas which is removed at line 20. The biogas may be used as an energy source, such as fuel to heat the anaerobic reactor and/or fuel for furnaces in other portions of an industrial plant. The effluent is removed from the anaerobic zone 18 and fed through line 22 to the aerobic zone 24.

The aerobic zone 24 contains a biomass in the form of an activated sludge. The activated sludge contains microorganisms capable of digesting organic matter in an aerobic environment. The aerobic zone 22 includes an inlet 26 for a source 28 of oxygen, such as air or pure oxygen. In one particular embodiment, air is fed through the bottom of the aerobic zone so that the rising air can be also serve the purpose of promoting contact between the activated sludge and the wastewater. Although the aerobic zone 24 has been shown schematically as a single stage, those skilled in the art will appreciate that the aerobic zone 24 may be configured in multiple reactors in series or parallel.

Wastewater effluent is removed from the aerobic zone 24 via line 30 and sent to the clarifier zone 32 for settling of any entrained activated sludge or other solids before dispersal of the wastewater via outlet 34. Although the clarifier zone 32 has been shown schematically in FIG. 1 as a single stage, those skilled in the art will appreciate that the clarifier zone may include multiple stages. A portion of the wastewater in the clarifier zone 32 may be recycled via recycle line 36 to the pressure equalization tank 14.

A portion of the activated sludge in the aerobic zone 24 is removed via a sludge transfer line 38 and continuously fed to the anaerobic zone 18. Surprisingly, the activated sludge may be transferred directly via sludge transfer line 38 without any treatment steps or preparatory processing for introduction of the sludge into the anaerobic zone 24, thereby reducing the costs of the system. For example, the cells of the microorganisms are not destroyed via mechanical, thermal, or chemical mechanisms before the sludge is introduced into the anaerobic zone 24.

Transferring sludge from the aerobic zone 24 to the anaerobic zone 18 serves dual purposes. First, the transfer reduces or eliminates the need for costly downstream processing, such as drying, incinerating, or landfilling of waste or excess activated sludge. In one particular embodiment, substantially the entire portion of waste activated sludge not needed to operate the aerobic zone 24 is transferred to the anaerobic zone via the sludge transfer line, that is, the entire portion except small portions that may escape the system unintentionally, such as entrained portions exiting via effluent line 30.

Second, the addition of the recycled activated sludge to the anaerobic zone 18 unexpectedly and surprisingly increases the growth of granules of biomass in the anaerobic zone 18. While not desiring to be bound by theory, it is believed that not all the aerobic microorganisms are destroyed or digested in the anaerobic zone 18, but rather they may adjust to the anaerobic conditions by functioning with oxygen substitutes, such as sulfur or phosphorus. Accordingly, it is further believed that in many applications the activated sludge in the aerobic zone and the anaerobic zone has similar microorganism populations.

The increase in the growth of biomass may be demonstrated by growth yield. Growth yield is defined as the mass of granular sludge produced divided by the mass of the total organic carbon (TOC) removed, and may be calculated by the following equation:

$$growth yield = \frac{Δ mass anaerobic zone granules + mass {TSS}_{affluent}}{( mass {TOC}_{in} - mass {TOC}_{out} )}$$

where:

mass TSS_{effluent} is mass of the total suspended solids escaping the anaerobic zone in the water effluent from the zone

mass TOCᵢₙ is the mass of the total organic carbon in the feed to the anaerobic zone

mass TOCₒᵤₜ is the mass of the total organic carbon in the effluent from the anaerobic zone

Without the recycling of unprocessed activated sludge from the aerobic zone 24 to the anaerobic zone 18, the baseline growth yield of biomass granules in anaerobic zone is typically no greater than about 5.5% or 6%. Despite a positive growth yield, such systems typically experience a net loss of biomass granules through entrainment of solids in the effluent. However, with the direct addition of activated sludge, growth yields can be greater than about 5.5% or 6. In one particular embodiment, growth yield of biomass granules may be at least about 7%. In one particular embodiment, growth yield of biomass granules may be at least about 8%. In another embodiment, growth yields may be at least about 10%. In other particular embodiment, growth yields may be at least about 12%, at least about 15%, at least about 18%, or at least about 20%.

The increased growth yields either reduce or eliminate the need to replace costly granules in the anaerobic zone 18. In one particular embodiment, an excess of granules, that is, more granules than is needed to operate the anaerobic zone 18 at a desired granular inventory, is produced. In this embodiment, excess granules are removed from the anaerobic zone via outlet 40. Excess granules may be used or sold for use in other wastewater treatment systems.

In one preferred embodiment, the outlet 40 for removing excess granules is spaced from the bottom of the reactor(s) in the anaerobic zone 18 so that removed granules are substantially free of metals and inert materials that may aggregate at or near the bottom of the reactor(s). These metals and/or inert materials may be removed the reactor(s) via a purge line 42 that is located at or near the bottom of the reactor(s) in the anaerobic zone 18.

### Example 1

A method and system according to one embodiment of the present invention was demonstrated in a laboratory pilot plant. The anaerobic zone was configured as a 10 L upflow anaerobic sludge blanket reactor (UASB) with an overflow recycle. The reactor was maintained at 38° C. and a pH of 6.8.

A wastewater stream from a purified terephthalic acid manufacturing process containing varying amounts of TOC was fed to the UASB with an upflow velocity of 2.2 m/hr. A portion of the water withdrawn from the top of the UASB reactor was recycled and another portion was fed to an aerobic zone configured as three aeration basins in series. Air was fed to each of the basins. Waste sludge was recycled from the bottom of the last aeration basin back to the UASB, and the amount of transferred sludge was measured as a ratio of recycled waste activated sludge solids to solids in the UASB. In an additional test to establish a baseline growth yield, no waste sludge was transferred back to the UASB.

The results shown in Table 1 demonstrate that the method of the present invention unexpectedly provides increased granular biomass growth in the UASB, as demonstrated by an increase in the growth yield when waste activated sludge is transferred directly from the aerobic zone to the anaerobic zone without any pretreatment or processing steps.

TABLE 1
Laboratory Pilot Plant Testing

| | | Volumetric load | | Ratio of | Ratio of | Biomass |
|---|---|---|---|---|---|---|
| | | (kg TOC per m³ | TOC system | recycled WAS | recycled WAS | Granular |
| | TOC feed | UASB reactor per | effluent | solids to | COD to Total | Growth |
| Run No. | (ppm) | day) | (ppm) | UASB solids | Feed COD | Yield |
| Baseline | 2,716 | 9.1 | 39 | 0.00% | 0.00% | 5.14% |
| Test #1 | 2,737 | 8.0 | 16 | 1.36% | 4.78% | 10.18% |
| Test #2 | 2,632 | 7.8 | 64 | 2.68% | 8.25% | 14.55% |
| Test #3 | 1,684 | 10.6 | 20 | 2.81% | 9.78% | 16.85% |
| Test #4 | 1,745 | 10.5 | 19 | 3.57% | 11.49% | 23.32% |

### Example 2

A method and system according to one embodiment of the present invention was also demonstrated in a commercial scale pilot plant. The anaerobic zone was configured as a Biothane EGSB reactor having a reactor volume of 851 cubic meters. The reactor was maintained at 38° C. and a pH range of 6.8 to 7.0.

A wastewater stream from a purified terephthalic acid manufacturing process containing varying amounts of TOC was fed to the reaction with an upflow velocity of 2.6 m/hr. A portion of the water withdrawn from the top of the reactor was recycled and another portion was fed to an aerobic tank Waste sludge was transferred from the bottom of the aeration tank back to the anaerobic reactor, and measured as a ratio of recycled waste activated sludge solids to solids in the anaerobic reactor. In two additional baseline tests, no waste sludge was transferred back to the anaerobic reactor.

The results shown in Table 2 demonstrate that the method of the present invention unexpectedly provides increased granular biomass growth in the anaerobic reactor, as demonstrated by an increase in the growth yield when waste activated sludge is transferred directly from the aerobic zone to the anaerobic zone without any pretreatment or processing steps.

TABLE 2
Commercial Scale Pilot Plant Testing

| | | Volumetric load | | Ratio of | Ratio of | Biomass |
|---|---|---|---|---|---|---|
| | | (kg TOC per m³ | TOC system | recycled WAS | recycled WAS | Granular |
| | TOC feed | UASB reactor per | effluent | solids to | COD to Total | Growth |
| Run No. | (ppm) | day) | (ppm) | UASB solids | Feed COD | Yield |
| Baseline #1 | 4,803 | 4.23 | 365 | 0.00% | 0.00% | 5.5% |
| Baseline #2 | 5,589 | 6.18 | 1274 | 0.00% | 0.00% | 6% |
| Test #1 | 4,938 | 4.57 | 283 | 1.07% | 4.23% | 12% |
| Test #2 | 4,639 | 6.06 | 281 | 1.76% | 5.20% | 18% |

It should be readily understood by those persons skilled in the art that the present invention is susceptible of a broad utility and application. Many embodiments and adaptations of the present invention other than those herein described, as well as many variations, modifications and equivalent arrangements will be apparent from or reasonably suggested by the present invention and the foregoing description thereof, without departing from the substance or scope of the present invention.

Accordingly, while the present invention has been described herein in detail in relation to specific embodiments, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

1. A method for treating wastewater, comprising
treating wastewater in an anaerobic zone to remove organic matter from the wastewater and to form granules of a biomass;
transferring wastewater effluent from the anaerobic zone to an aeration zone;
treating the wastewater effluent with a source of oxygen and an activated sludge in the aeration zone to further remove organic matter from the wastewater effluent and to form additional activated sludge;
transferring a portion of the activated sludge from the aeration zone to the anaerobic zone; and
wherein the growth yield of the granules of biomass is greater than about 6%

2. The method of claim 1, further comprising:
removing a portion of the granules of biomass from the anaerobic zone.

3. The method of claim 1, wherein anaerobic zone comprises an upflow anaerobic sludge blanket reactor.

4. The method of claim 2, wherein the removed portion of the granules of biomass comprises an excess of granules formed in the anaerobic zone.

5. The method of claim 1, wherein the growth yield of biomass in the anaerobic zone is at least about 7%.

6. The method of claim 1, wherein the growth yield of biomass in the anaerobic zone is at least about 12%.

7. The method of claim 1, wherein the wastewater comprises industrial wastewater.

8. The method of claim 1, wherein the wastewater comprises effluent from a process for manufacturing of terephthalic acid.

9. The method of claim 1, wherein the wastewater comprises effluent from a process for manufacturing a biofuel.

10. The method of claim 1, wherein substantially no activated sludge is removed from the aeration zone during operation other than the portion transferred from the aeration zone to the anaerobic zone.

11. The method of claim 1, wherein portion of the activated sludge transferred from the aeration zone to the anaerobic zone is transferred directly and without any treatment steps.

12. A method for treating wastewater, comprising
treating wastewater in an anaerobic zone to remove organic matter from the wastewater and to form granules of a biomass;
transferring wastewater effluent from the anaerobic zone to an aeration zone;
treating the wastewater effluent with a source of oxygen and an activated sludge in the aeration zone to further remove organic matter from the wastewater effluent and to form additional activated sludge;
transferring a portion of the activated sludge from the aeration zone to the anaerobic zone; and
removing a portion of the granules of biomass from the anaerobic zone.

13. The method of claim 12, wherein anaerobic zone comprises an upflow anaerobic sludge blanket reactor.

14. The method of claim 12, wherein the removed portion of the granules of biomass comprises an excess of granules formed in the anaerobic zone.

15. The method of claim 12, wherein the wastewater comprises industrial wastewater.

16. The method of claim 12, wherein the wastewater comprises effluent from a process for manufacturing of terephthalic acid.

17. The method of claim 12, wherein the wastewater comprises from a process for manufacturing a biofuel.

18. The method of claim 12, wherein substantially no activated sludge is removed from the aeration zone during operation other than the portion transferred from the aeration zone to the anaerobic zone.

19. The method of claim 12, wherein portion of the activated sludge transferred from the aeration zone to the anaerobic zone is transferred directly and without any treatment steps.

20. A system for treating wastewater, comprising
an anaerobic zone having a wastewater inlet, the anaerobic zone containing granules of a biomass adapted to remove organic matter in the wastewater and form additional granules of the biomass;
an aeration zone in fluid communication with the anaerobic zone;
a sludge transfer line fluidly connecting the aeration zone and the anaerobic zone; and
an outlet in the anaerobic zone adapted to recover granulated biomass from the anaerobic zone.
